(19) United States
(12) Patent Application Publication
(10) Pub. No.: US 2024/0373318 A1
(43) Pub. Date: Nov. 7, 2024

(54) COMMUNICATION SYSTEM, COMMUNICATION METHOD, AND CONTROL DEVICE

(71) Applicant: NIPPON TELEGRAPH AND TELEPHONE CORPORATION, Tokyo (JP)

(72) Inventors: Hiroyuki FURUYA, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/685,906

(22) PCT Filed: Sep. 28, 2021
(86) PCT No.: PCT/JP2021/035541

§ 371 Date: Feb. 23, 2024

(51) Int. Cl. H04W 40/12; H04B 10/079; H04L 1/00; H04Q 11/00; H04W 52/24

(52) U.S. Cl. CPC H04W 40/12; H04B 10/07953; H04Q 11/0062; H04W 52/241; H04L 1/0003; H04L 1/0009; H04L 1/0018; H04Q 2011/0073; H04Q 2011/0081

(57) ABSTRACT

An object of the present invention is to prevent deterioration in communication quality due to rainfall in a wireless line through rainfall prediction using an optical fiber transmission route and a wireless transmission route. In a communication system, a transmission side facility and a reception side facility are connected through two routes which are an optical fiber transmission route and a wireless transmission route. The communication system performs deterioration prevention control for communication quality due to rainfall in the wireless route before rainfall by measuring a delay amount of the wireless transmission route 2 with respect to the optical fiber transmission route which is not affected by rainfall and by measuring a minute delay of the radio waves due to a rainfall influence to measure a water vapor amount.

### TECHNICAL FIELD

The present disclosure relates to a communication system, a communication method, and a control device, and more particularly, to an improvement in communication quality of fixed micro-wireless communication for rainfall.

### BACKGROUND ART

In recent years, a rapid increase in rainfall (guerilla rainstorm) which is difficult to predict in weather forecasts of the related art has occurred in various places, and the frequency thereof has also been increasing. In fixed micro-wireless communication, the attenuation of arriving radio waves due to rainfall cannot be avoided due to the physical restriction of absorption of the radio waves by raindrops. For example, as illustrated in (A) of FIG. 7, when rain falls on a wireless route, radio waves reaching a wireless device B become weak, and communication quality deteriorates.

As one scheme of ensuring communication quality, a control scheme of increasing transmission power by observing attenuation of radio waves due to rainfall is known. For example, as shown in (B) of FIG. 7, the wireless device B always measures the reception power. When an attenuation amount of the radio waves from the wireless device A exceeds a threshold, a method (ATPC function) of notifying the wireless device A with a control signal for increasing transmission power and compensating for reception power is known.

However, the notification with the control signal is a notification that is output after the reception power actually becomes weak after rainfall occurs. Therefore, there is a possibility of the control not being in time when the rainfall suddenly increases, and there is a possibility of the control signal not reaching the wireless device A due to rainfall attenuation, and there is a possibility of communication quality deteriorating and the communication being disconnected.

As another scheme of ensuring communication quality, a control scheme of observing attenuation of radio waves due to rainfall and changing a modulation scheme to a scheme resistant to rainfall is known. For example, as shown in (C) of FIG. 7, the wireless device B always measures reception power. When the radio waves from the wireless device A become weaker than the threshold, a scheme (adaptive modulation scheme) in which the wireless device A notifies with a control signal for changing a modulation scheme operating even with low reception power to achieve communication stability is known.

However, as in the above-described control scheme of increasing the transmission power, the notification with the control signal is a notification that is output after rainfall occurs and then the reception power actually becomes weak. Therefore, there is a possibility of the control not being in time.

The applicant has recognized the following literatures as related to the present disclosure.

### CITATION LIST

### Patent Literature

[PTL 1] WO 2016/035496
[PTL 2] Japanese Patent Application Laid-open No. 2013-224884
[PTL 3] Japanese Patent Application Laid-open No. H02-280082

### Non Patent Literature

[NPL 1] Possibilities of “GPS meteorology” for predicting weather at electronic reference points, Cabinet Office, Government of Japan, [retrieved on Sep. 16, 2021], Internet <URL: https://qzss.go.jp/info/archive/mri-jma_180517.html
[NPL 2] Research and development of method of estimating water vapor amount using digital terrestrial broadcasting waves, Japan Science and Technology Agency, [retrieved on Sep. 16, 2021], Internet <URL: https://www.jst.go.jp/sip/dl/k08/sympo2017/poster_05.pdf>

### SUMMARY OF INVENTION

### Technical Problem

As described above, the control scheme cannot handle an increase in sudden rainfall after a rainfall event occurs. Therefore, it is necessary to predict rainfall and prepare it in advance. For rainfall prediction, PTL 1 discloses that a water vapor amount in the atmosphere increases before rainfall occurs. PTL 1 discloses a method of measuring a water vapor amount in the atmosphere that rises before rainfall occurs from a delay amount of a GPS signal observed from the GPS signal in a dry atmosphere.

However, in order to accurately detect a minute delay of radio waves when the water vapor amount increases before rainfall for rainfall prediction, it is considered that the delay amount of wireless route with respect to a wired route which is not affected by rainfall with respect to the same signal is preferably measured.

To solve the above-described problem, an object of the present disclosure is to provide a communication system, a communication method, and a control device capable of preventing deterioration in communication quality due to rainfall in a wireless line through rainfall prediction using an optical fiber transmission route and a wireless transmission route.

### Solution to Problem

A first viewpoint relates to a communication system. The communication system has an optical fiber transmission route, a wireless transmission route, a transmission side facility, and a reception side facility.

The transmission side facility is connected to one end of the optical fiber transmission route and one end of the wireless transmission route and transmits signals to both the optical fiber transmission route and the wireless transmission route at the same transmission timing before rainfall.

The reception side facility is connected to the other end of the optical fiber transmission route and the other end of the wireless transmission route and configured to measure a delay amount of a signal through the wireless transmission route with respect to a signal through the optical fiber transmission route based on a difference between a reception timing at which the signal is received from the optical fiber transmission route and a reception timing at which the signal is received from the wireless transmission route.

When a predicted rainfall amount corresponding to the delay amount is equal to or greater than a threshold or when the predicted rainfall amount based on a rate of increase of the delay amount is equal to or greater than the threshold, the transmission side facility raises transmission power of a signal transmitted to the wireless transmission route compared with transmission power in a normal time in which the predicted rainfall amount is less than the threshold or changes a modulation scheme to a scheme more resistant to rainfall than in the normal time.

A second viewpoint further has the following features in addition to the first viewpoint.

The transmission side facility includes an optical transmission device and a wireless device.

At the same transmission timing before rainfall, the optical transmission device may transmit a timing signal as the signal to the optical fiber transmission route, and the wireless device may transmit the timing signal supplied from the optical transmission device to the wireless transmission route.

A third viewpoint further has the following features in addition to the first viewpoint.

The transmission side facility includes a wireless device and an optical transmission device.

The signal may include a wireless synchronization signal.

At the same transmission timing before rainfall, the wireless device may transmit the wireless synchronization signal to the wireless transmission route; and the optical transmission device may transmit a superimposed signal obtained by superimposing the wireless synchronization signal supplied from the wireless device on a main signal to an optical fiber transmission route.

A fourth viewpoint further has the following features in addition to the first viewpoint.

The transmission side facility may include a wireless device and an optical transmission device.

The signal may include a wireless modulation signal including a wireless synchronization signal and important communication data.

At the same transmission timing before rainfall, the wireless device may transmit the wireless modulation signal to the wireless transmission route and the optical transmission device may transmit a superimposed signal obtained by superimposing the wireless modulation signal supplied from the wireless device on a main signal to the optical fiber transmission route.

When the wireless communication through the wireless transmission route is interrupted, the reception side facility may compensate for the wireless communication through the wireless transmission route with the important communication data included in the wireless modulation signal separated from the superimposed signal received through the optical fiber transmission route.

A fifth viewpoint further has the following features in addition to any one of the first to fourth viewpoints. The reception side facility may estimate the water vapor amount in a wireless section in which the wireless transmission route is used based on the delay amount or a rate of increase of the delay amount.

The reception side facility may calculate the predicted rainfall amount based on the estimated water vapor amount. When the predicted rainfall amount is equal to or more than the threshold, the reception side facility may notify the transmission side facility with a control signal for raising transmission power of a signal to be transmitted to the wireless transmission route compared with transmission power in the normal time or changing a modulation scheme to a scheme more resistant to rainfall than in the normal time.

The transmission side facility may change the transmission power or the modulation scheme of the signal to be transmitted to the wireless transmission route in accordance with the control signal.

A sixth viewpoint further has the following features in addition to any one of the first to fifth viewpoints. When the predicted rainfall amount is equal to or greater than the threshold, the transmission side facility may change the modulation scheme to a scheme having a lower multi-value number than in the normal time, or change the modulation scheme to a scheme having a higher error correction capability than in the normal time.

A seventh viewpoint relates to a wireless communication method in a wireless communication system.

In the communication system, a transmission side facility and a reception side facility are connected through two routes which are an optical fiber transmission route and a wireless transmission route.

In the communication method, signals are transmitted from the transmission side facility to both the optical fiber transmission route and the wireless transmission route at the same transmission timing before rainfall.

In the communication method, a delay amount of a signal through the wireless transmission route with respect to a signal through the optical fiber transmission route is measured based on a difference between a reception timing at which the signal is received from the optical fiber transmission route and a reception timing at which the signal is received from the wireless transmission route.

In the communication method, transmission power of a signal transmitted from the transmission side facility to the wireless transmission route is raised compared with transmission power in a normal time in which the predicted rainfall amount is equal to or greater than a threshold or a modulation scheme is changed to a scheme more resistant to rainfall than in the normal time when the predicted rainfall amount corresponding to the delay amount is less than the threshold or when the predicted rainfall amount based on a rate of increase of the delay amount is equal to or greater than the threshold.

An eighth viewpoint relates to a control device of a reception side facility.

The reception side facility is connected to a transmission side facility through two routes which are an optical fiber transmission route and a wireless transmission route.

The transmission side facility may transmit signals to both the optical fiber transmission route and the wireless transmission route at the same transmission timing before rainfall.

The control device includes a section water vapor amount calculation unit, a rainfall amount prediction unit, and a communication scheme determination unit.

The section water vapor amount calculation unit measures a delay amount of a signal through the wireless transmission route with respect to a signal through the optical fiber transmission route based on a difference between a reception timing at which the signal is received from the optical fiber transmission route and a reception timing at which the signal is received from the wireless transmission route. Further, the section water vapor amount calculation unit estimates estimate a water vapor amount in the wireless section in which the wireless transmission route is used based on the delay amount or the rate of increase of the delay amount.

The rainfall amount prediction unit calculates a predicted rainfall amount based on the predicted water vapor amount. A communication scheme determination unit notifies the transmission side facility with a control signal for raising transmission power of a signal to be transmitted to the wireless transmission route compared with transmission power in a normal time in which the predicted rainfall amount is less than the threshold or changing a modulation scheme to a scheme more resistant to rainfall than in the normal time when the predicted rainfall amount is equal to or more than the threshold.

The transmission side facility changes the transmission power or the modulation scheme of a signal to be transmitted to the wireless transmission route in accordance with the control signal.

### Advantageous Effects of Invention

According to the present disclosure, deterioration in communication quality due to rainfall of a wireless channel can be prevented through rainfall prediction using an optical fiber transmission route and a wireless transmission route.

### BRIEF DESCRIPTION OF DRAWINGS

FIG. 1 is a diagram illustrating a configuration of a communication system according to a first embodiment.

FIG. 2 is a block diagram illustrating an overview of a function of the communication system according to the first embodiment.

FIG. 3 is a diagram illustrating an example of a configuration of a communication system according to a second embodiment.

FIG. 4 is a block diagram illustrating an overview of a function of the communication system according to the second embodiment.

FIG. 5 is a block diagram illustrating an overview of a function of a communication system according to a third embodiment.

FIG. 6 is a block diagram illustrating an example of a hardware configuration of transmission side facility and reception side facility.

FIG. 7 is a diagram illustrating a technique according to the present disclosure.

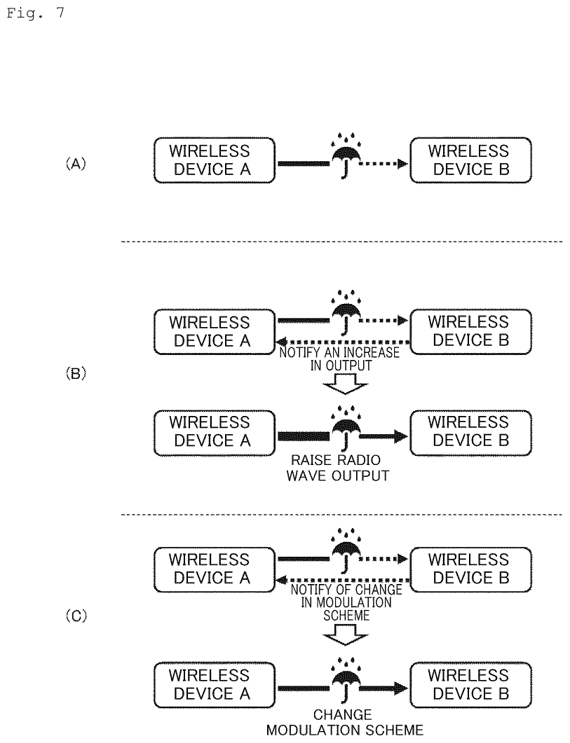

### DESCRIPTION OF EMBODIMENTS

Hereinafter, embodiments of the present invention will be described in detail with reference to the drawings.

Constituents that are common in each drawing are denoted by the same reference numerals, and repeated description of the constituents will be omitted.

### First Embodiment

### 1. Communication System

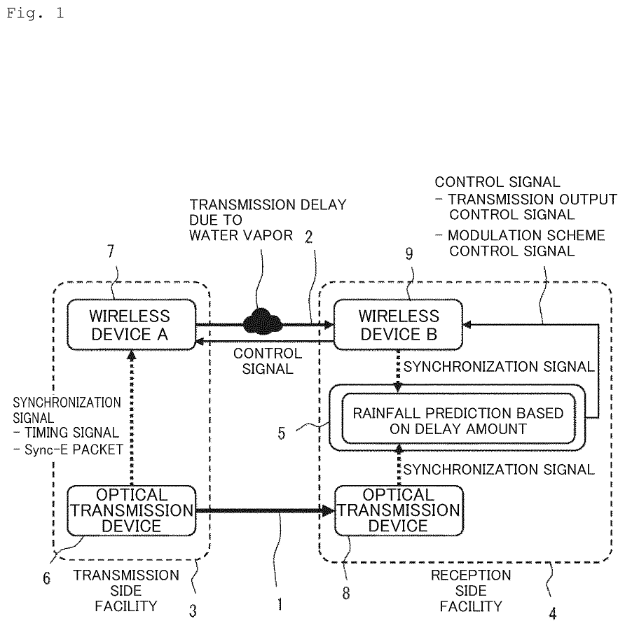

FIG. 1 is a diagram illustrating an example of a configuration of a communication system according to a first embodiment. The communication system shown in FIG. 1 is, for example, a fixed microwave communication system, and connects a transmission side facility 3 to the reception side facility 4 through two routes which are an optical fiber transmission route 1 and a wireless transmission route 2.

In wireless communication through the wireless transmission route 2, attenuation of arriving radio waves due to rainfall cannot be avoided due to physical restriction such as absorption of the radio waves by raindrops. In recent years, sudden rainfall has been increased, and it is desirable to perform control for predicting rainfall and inhibiting deterioration in communication quality in advance. In order to predict the rainfall, it is preferable to accurately detect a minute delay of radio waves when a water vapor amount increases before the rainfall. Accordingly, in the embodiment, deterioration prevention control for communication quality due to rainfall in the wireless route before rainfall is performed by measuring a delay amount (delay time) of the wireless transmission route 2 with respect to the optical fiber transmission route 1 which is not affected by rainfall and by measuring a minute delay of the radio waves due to a rainfall influence to measure a water vapor amount.

### 2. Deterioration Prevention Control for Communication Quality of Wireless Route Using Timing Signal or the Like of Optical Transmission Device

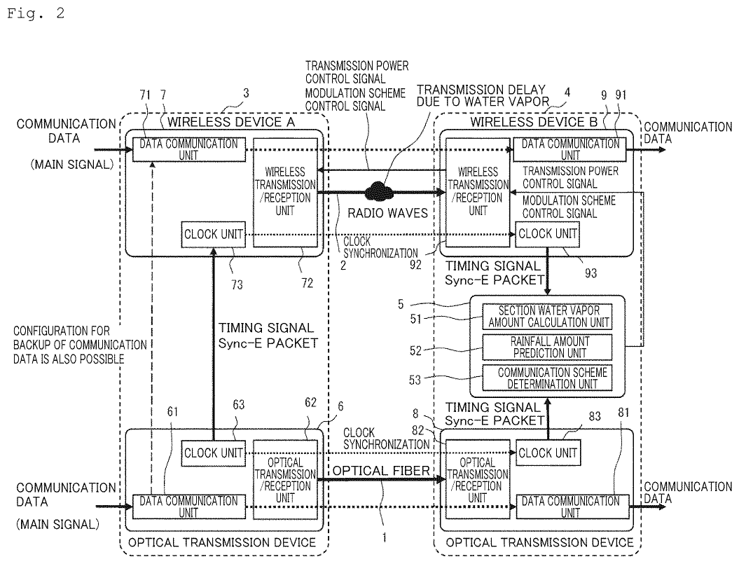

A communication system according to the embodiment will be described with reference to FIG. 2. FIG. 2 is a block diagram illustrating an overview of a function of the communication system according to the first embodiment.

The transmission side facility 3 is connected to one end of the optical fiber transmission route 1 and one end of the wireless transmission route 2, and includes an optical transmission device 6 and a wireless device 7. The optical transmission device 6 includes a data communication unit 61, an optical transmission/reception unit 62, and a clock unit 63. The wireless device 7 includes a data communication unit 71, a wireless transmission/reception unit 72, and a clock unit 73.

The reception side facility 4 is connected to the other end of the optical fiber transmission route 1 and the other end of the wireless transmission route 2, and includes a control device 5, an optical transmission device 8, and a wireless device 9. The optical transmission device 8 includes a data communication unit 81, an optical transmission/reception unit 82, and a clock unit 83. The wireless device 9 includes a data communication unit 91, a wireless transmission/reception unit 92, and a clock unit 93.

The communication data includes audio data, image data, video data, document data, and the like. The communication data input to the optical transmission device 6 is output from the optical transmission device 8 through the data communication unit 61, the optical transmission/reception unit 62, the optical fiber transmission route 1, the optical transmission/reception unit 82, and the data communication unit 81. The communication data input to the wireless device 7 is output from the wireless device 9 through the data communication unit 71, the wireless transmission/reception unit 72, the wireless transmission route 2, the wireless transmission/reception unit 92, and the data communication unit 91.

The clock unit 63 and the clock unit 83 share a timing of a boundary of signals through clock synchronization. In the communication system according to the embodiment, a synchronization signal (timing signal, sync-E packet, etc.) for clock synchronization is supplied from the optical transmission device 6 to the wireless device 7. Then, at the same transmission timing, the optical transmission device 6 transmits the synchronization signal to the optical fiber transmission route 1 and the wireless device 7 transmits the synchronization signal supplied from the optical transmission device 6 to the wireless transmission route 2. The synchronization signal is transmitted regardless of before or after rainfall. In this way, the transmission side facility 3 can transmit signals to both the optical fiber transmission route 1 and the wireless transmission route 2 at the same transmission timing before rainfall.

The clock unit 83 of the optical transmission device 8 outputs the synchronization signal received through the optical fiber transmission route 1 to the control device 5. The clock unit 93 of the wireless device 9 outputs the synchronization signal received through the wireless transmission route 2 to the control device 5. The control device 5 measures a transmission delay and a delay variation of a wireless section by comparing the synchronization signal extracted from the optical transmission device 8 with the synchronization signal extracted from the wireless device 9. The control device 5 estimates a water vapor amount in the wireless section from the delay amount before rainfall and the delay variation, and appropriately controls transmission power and a modulation scheme of the wireless device 7.

Hereinafter, a more detailed description will be made. The control device 5 includes a section water vapor amount calculation unit 51, a rainfall amount prediction unit 52, and a communication scheme determination unit 53.

The section water vapor amount calculation unit 51 measures a delay amount of a signal through the wireless transmission route 2 with respect to a signal through the optical fiber transmission route 1 based on a difference between a reception timing at which the synchronization signal is received from the optical fiber transmission route 1 and a reception timing at which the synchronization signal is received from the wireless transmission route 2. In addition, a variation amount and a variation rate are measured by comparing the delay amount with a past delay amount.

Further, based on the delay amount or a rate of increase of the delay amount, the section water vapor amount calculation unit 51 estimates a water vapor amount in a wireless section in which the wireless transmission route 2 is used. For example, the section water vapor amount calculation unit 51 stores in advance a correspondent relation between the delay amount before rainfall and the water vapor amount or a correspondent relation between a rate of increase of the delay amount before rainfall and the water vapor amount. For example, a technique for estimating a water vapor amount from the delay amount of radio waves in the wireless transmission route 2 in NPL 2 can be applied. A case where a delay of the radio waves is increased more than a certain value as compared with the case of a fine weather or a case where the delay is rapidly increased means that the water vapor amount in the wireless route section is increased. Therefore, heavy rain due to a sudden change of weather can be predicted using the above-described water vapor estimation scheme. Further, it is also possible to reinforce a prediction result by using a weather forecast of the related art, a dedicated weather radar, a camera, or the like.

The rainfall amount prediction unit 52 calculates a predicted rainfall amount based on the estimated water vapor amount. For example, the rainfall amount prediction unit 52 calculates a future predicted rainfall amount corresponding to the water vapor amount before rainfall based on past data defining a relation between the water vapor amount before rainfall and a later rainfall amount, and information provided from a weather company service.

The communication scheme determination unit 53 notifies the transmission side facility 3 of a transmission power control signal for raising transmission power of a signal transmitted from the transmission side facility 3 to the wireless transmission route 2 compared with transmission power in a normal time in which the predicted rainfall amount is less than the threshold when the predicted rainfall amount is equal to or more than the threshold. For example, the threshold and the normal transmission power are set in consideration of a rainfall margin set from a statistical area rainfall amount. When the predicted rainfall amount is equal to or more than the threshold, there is a concern of an increase in sudden rainfall exceeding the rainfall margin difficult to predict in weather forecast. Therefore, when the predicted rainfall amount is equal to or more than the threshold, the control device 5 notifies the wireless device 7 of the transmission power control signal for increasing transmission power compared with transmission power in the normal time. For example, control is performed such that the transmission power is larger as the predicted rainfall amount is larger.

Alternatively, the communication scheme determination unit 53 notifies the transmission side facility 3 of a modulation scheme control signal for changing the modulation scheme to a scheme more resistant to rainfall than in a normal time when the predicted rainfall amount is equal to or more than the threshold. For example, when the predicted rainfall amount is equal to or more than the threshold, the modulation scheme is changed to a modulation scheme having a lower multi-value number than in the normal time. As an example, the scheme is changed from 64 QAM to the 16 QAM. For example, the transmission side facility 3 is notified of a modulation scheme control signal for changing to a modulation scheme having lower frequency utilization efficiency than in the normal time but a higher error correction capability. As one example, a modulation scheme (TC8 PSK) having high frequency utilization efficiency is changed to a modulation scheme (QPSK, BPSK) having low frequency utilization efficiency and high error correction capability.

Thus, when the rainfall margin exceeds a required rainfall margin, the transmission power can be improved and the modulation scheme can be optimized. The communication scheme determination unit 53 outputs a control signal for returning the transmission power or the modulation scheme to a normal setting when the predicted rainfall amount returns from the threshold or more to a value less than the threshold.

The transmission side facility 3 changes the transmission power or the modulation scheme of a signal transmitted from the wireless device 7 to the wireless transmission route 2 according to the received control signal (the transmission power control signal or the modulation scheme control signal).

### 3. Advantageous Effects

As described above, in the communication system according to the embodiment, signals are transmitted to both the optical fiber route in which there is no rainfall influence and the fixed micro-wireless route in which there is a rainfall. influence at the same timing before rainfall, and the signals are compared on the reception side, so that the delay of radio waves in the wireless route with respect to the wired route can be accurately observed. Therefore, the delay amount due to a rainfall influence can be observed with high accuracy. As a result, the communication system can accurately calculate the predicted rainfall amount of the wireless section based on the delay amount, and can prevent deterioration in communication quality against rainfall of the wireless section by controlling the transmission side facility 3 before rainfall.

In the communication system according to the embodiment, it is not necessary to set a margin in advance in consideration of an increase in sudden rainfall (guerilla rainstorm) with respect to a rainfall margin set from an entire statistical rainfall amount of an area, and it is possible to reduce unnecessary radio wave output for securing the rainfall margin. When an unexpected water vapor amount is observed on the wireless route, a margin for rainfall can be optimized by controlling the transmission power and the modulation scheme based on actual measurement. It is possible to improve a communication speed in fine weather through precise control of the modulation scheme. The above-described communication quality deterioration prevention control can be applied in addition to the prediction control by a general weather forecast.

### Second Embodiment

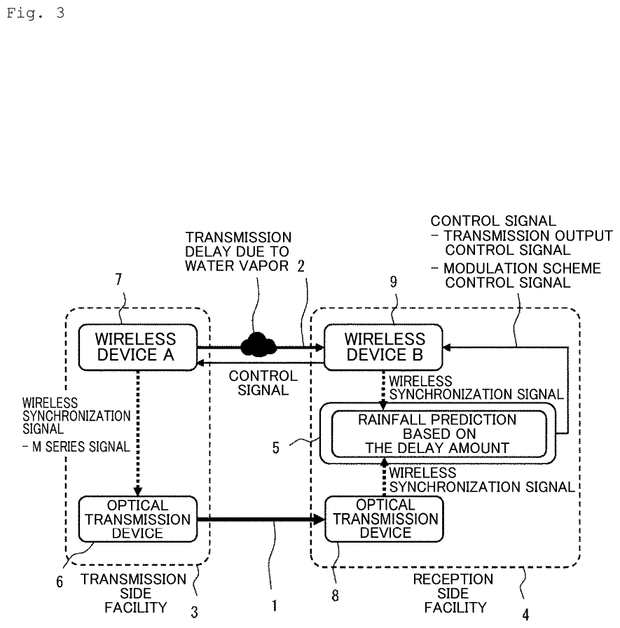

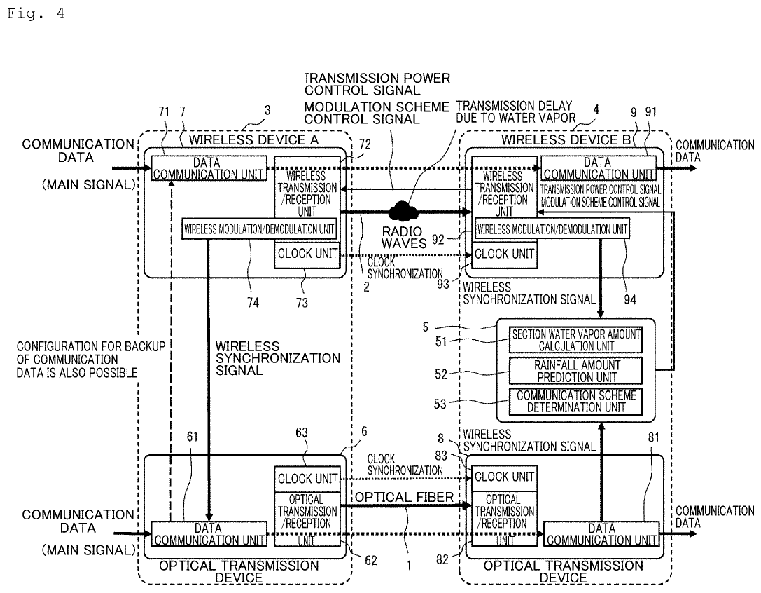

Next, a second embodiment of the present disclosure will be described with reference to FIGS. 3 and 4. Constituents that are common in the first embodiment are denoted by the same reference numerals, and repeated description of the constituents will be omitted.

### 1. Communication System

FIG. 3 is a diagram illustrating an example of a configuration of a communication system according to the second embodiment. The reception side facility 4 according to the above-described first embodiment supplies a synchronization signal (a timing signal or a sync-E packet) of the optical transmission device 6 to the wireless device 7, and transmits synchronization signals to both the optical fiber transmission route 1 and the wireless transmission route 2 at the same transmission timing before rainfall. The reception side facility 4 compares the reception timings of the signals from both the routes to measure a delay amount.

In order to detect a deviation in an arriving signal more accurately, a M series signal of the wireless device 7 is utilized in the second embodiment. Since the M series is a signal series for synchronizing the wireless devices with each other and is also used for measuring multipath reflection, the deviation in the arriving signal can be detected more accurately.

Accordingly, in the communication system according to the second embodiment, the reception side facility 4 supplies the wireless synchronization signal (M-series signal) of the wireless device 7 to the optical transmission device 6, and transmits the wireless synchronization signals to both the optical fiber transmission route 1 and the wireless transmission route 2 at the same transmission timing before rainfall. Then, the reception side facility 4 compares reception timings of the signals from both the routes to measure the delay amount.

### 2. Deterioration Prevention Control for Communication Quality of Wireless Route Using Wireless Synchronization Signal of Wireless Device

A communication system according to the embodiment will be described in more detail with reference to FIG. 4. FIG. 4 is a block diagram illustrating an overview of a function of the communication system according to the second embodiment.

The wireless modulation/demodulation unit 74 of the wireless device 7 converts communication data (main signal) into data which can be transmitted in a form of radio waves and outputs a wireless modulation signal. The wireless modulation signal includes communication data, and a wireless synchronization signal such as an M-series signal in the wireless modulation signal for synchronizing wireless devices with each other. The wireless modulation/demodulation unit 74 supplies a wireless synchronization signal from the wireless device 7 to the optical transmission device 6.

At the same transmission timing, the wireless device 7 transmits a wireless modulation signal including the wireless synchronization signal to the wireless transmission route 2, and the optical transmission device 6 transmits a superimposed signal obtained by superimposing the wireless synchronization signal supplied from the wireless device 7 on a main signal (communication data) to the optical fiber transmission route 1. The wireless modulation signal and the superimposed signal are transmitted regardless of before or after rainfall. In this way, the transmission side facility 3 can transmit signals to both the optical fiber transmission route 1 and the wireless transmission route 2 at the same transmission timing before rainfall.

The data communication unit 81 of the optical transmission device 8 separates the wireless synchronization signal from the superimposed signal received through the optical fiber transmission route 1 and outputs the wireless synchronization signal to the control device 5. The data communication unit 91 of the wireless device 9 outputs a wireless synchronization signal in the wireless modulation signal received through the wireless transmission route 2 to the control device 5.

The section water vapor amount calculation unit 51 of the control device 5 measures a delay amount of a signal through the wireless transmission route 2 with respect to a signal through the optical fiber transmission route 1 based on a difference between a reception timing at which the wireless synchronization signal is received from the optical fiber transmission route 1 and a reception timing at which the wireless synchronization signal is received from the wireless transmission route 2. Further, based on the delay amount or the rate of increase of the delay amount, the section water vapor amount calculation unit 51 estimates a water vapor amount in the wireless section in which the wireless transmission route 2 is used, as in the first embodiment.

Thereafter, as in the first embodiment, the control device 5 executes the processing of the rainfall amount prediction unit 52 and the communication scheme determination unit 53 to transmit a control signal. The transmission side facility 3 changes the transmission power or modulation scheme of a signal transmitted from the wireless device 7 to the wireless transmission route 2 in accordance with the received control signal (a transmission power control signal or a modulation scheme control signal).

### 3. Advantageous Effects

As described above, the optical transmission device 6 takes the lead in a timing in the first embodiment, whereas the wireless device 7 takes the lead in a timing in the timing in the second embodiment. In the communication system according to the second embodiment, the delay amount of the signal through the wireless transmission route 2 with respect to the signal through the optical fiber transmission route 1 can be measured with high accuracy based on the wireless synchronization signal of the wireless device 7 before rainfall. As a result, the communication system can accurately calculate the predicted rainfall amount of the wireless section based on the delay amount, and can prevent the deterioration in communication quality against the rainfall of the wireless section by controlling the transmission side facility 3 before rainfall.

### Third Embodiment

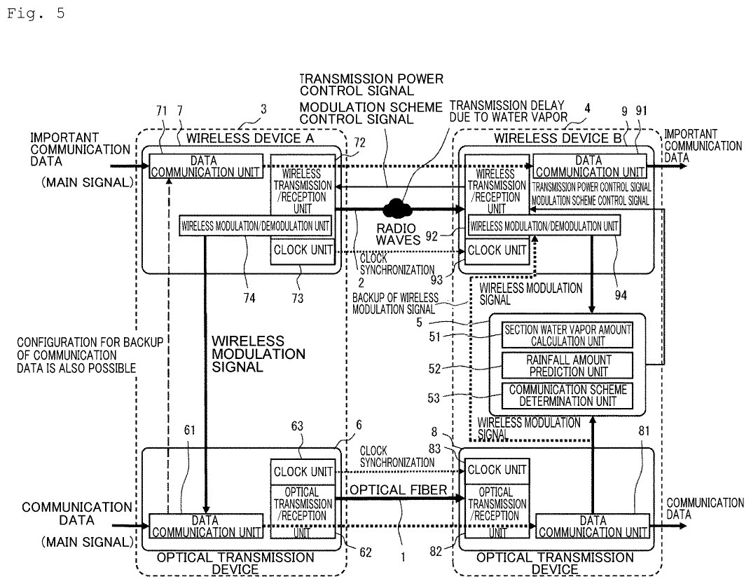

Next, a third embodiment of the present disclosure will be described with reference to FIG. 5. Constituents that are common in the first or second embodiment are denoted by the same reference numerals, and repeated description of the constituents will be omitted.

### 1. Communication System

The reception side facility 4 according to the above-described second embodiment supplies a wireless synchronization signal (M-series signal) of the wireless device 7 to the optical transmission device 6, and transmits a signal including the wireless synchronization signals to both the optical fiber transmission route 1 and the wireless transmission route 2 at the same transmission timing before rainfall. Then, the reception side facility 4 compares the reception timings of the signals from both the routes to measure a delay amount.

However, when important communication is performed on a wireless route, there is concern of communication interruption due to rainfall. Accordingly, in the communication system according to the third embodiment, the wireless modulation signal of the wireless transmission route 2 is superimposed on the transmission signal of the optical fiber transmission route 1, and the wireless modulation signal is transmitted even on a wired route.

### 2. Deterioration Prevention Control for Communication Quality of Wireless Route in Which Wireless Modulation Signal of Wireless Device is Used

The communication system according to the embodiment will be described with reference to FIG. 5. FIG. 5 is a block diagram illustrating an overview of a function of the communication system according to the third embodiment.

The wireless modulation/demodulation unit 74 of the wireless device 7 converts important communication data (main signal) into data which can be transmitted in a form of radio waves and outputs a wireless modulation signal. The wireless modulation signal includes important communication data and a wireless synchronization signal such as an M-series signal in the wireless modulation signal for synchronizing wireless devices. The wireless modulation/demodulation unit 74 supplies a wireless modulation signal from the wireless device 7 to the optical transmission device 6.

At the same transmission timing, the wireless device 7 transmits a wireless modulation signal to the wireless transmission route 2, and the optical transmission device 6 transmits a superimposed signal obtained by superimposing the wireless modulation signal supplied from the wireless device 7 on a main signal (communication data) to the optical fiber transmission route 1. The wireless modulation signal and the superimposed signal are transmitted regardless of before or after rainfall. In this way, the transmission side facility 3 can transmit signals to both the optical fiber transmission route 1 and the wireless transmission route 2 at the same transmission timing before rainfall.

The data communication unit 81 of the optical transmission device 8 separates the wireless modulation signal from the superimposed signal received through the optical fiber transmission route 1 and outputs the wireless modulation signal to the control device 5. The data communication unit 91 of the wireless device 9 outputs the wireless modulation signal received through the wireless transmission route 2 to the control device 5.

The section water vapor amount calculation unit 51 of the control device 5 measures a delay amount of a signal through the wireless transmission route 2 with respect to a signal through the optical fiber transmission route 1 based on a difference between a reception timing at which the wireless modulation signal is received from the optical fiber transmission route 1 and a reception timing at which the wireless modulation signal is received from the wireless transmission route 2. Further, based on the delay amount or the rate of increase in the delay amount, the section water vapor amount calculation unit 51 estimates a water vapor amount in the wireless section in which the wireless transmission route 2 is used, as in the first or second embodiment.

Thereafter, as in the first or second embodiment, the control device 5 executes the processing of the rainfall amount prediction unit 52 and the communication scheme determination unit 53 to transmit a control signal. The transmission side facility 3 changes the transmission power or the modulation scheme of a signal transmitted from the wireless device 7 to the wireless transmission route 2 in accordance with the received control signal (transmission power control signal or modulation scheme control signal).

The wireless modulation/demodulation unit 94 of the reception side facility 4 receives a wireless modulation signal separated from the superimposed signal received through the optical fiber transmission route 1 when wireless communication through the wireless transmission route 2 is interrupted. The wireless modulation/demodulation unit 94 compensates for the wireless communication through the wireless transmission route 2 with the important communication data included in the wireless modulation signal.

### 3. Advantageous Effects

As described above, according to the communication system according to the embodiment, it is possible to prevent deterioration in communication quality due to rainfall in the wireless section by controlling the transmission side facility 3 before rainfall using the wireless modulation signal including the wireless synchronization signal, as in the second embodiment. Furthermore, in the communication system according to the embodiment, even when wireless communication through the wireless transmission route 2 is interrupted due to rainfall, the wireless device 9 on the reception side can receive a wireless modulation signal through the optical fiber transmission route 1. Therefore, it is possible to compensate for the wireless communication through the wireless transmission route 2. As described above, in the communication system according to the embodiment, it is possible to implement backup of important communication.

### <Exemplified Hardware Configuration>

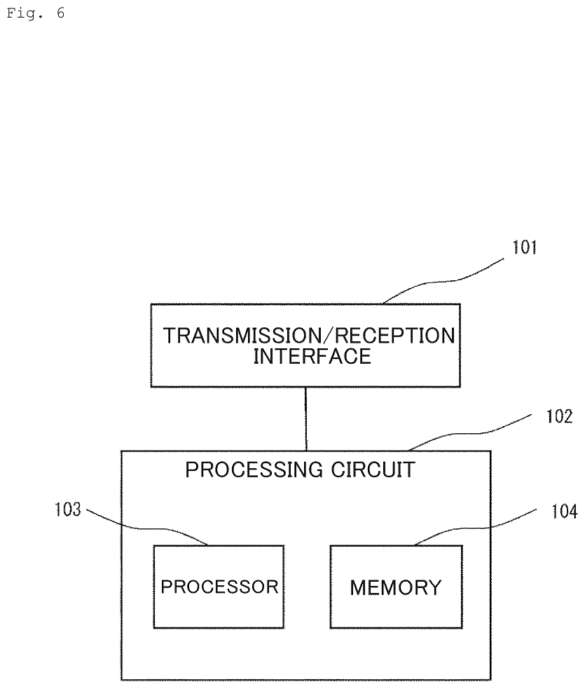

FIG. 6 is a block diagram illustrating a hardware configuration of the transmission side facility 3 and the reception side facility 4 according to the embodiment. The transmission side facility 3 and the reception side facility 4 each include a transmission/reception interface 101 and a processing circuit 102. The transmission/reception interface 101 includes a circuit that transmits and receives signals from and to outside.

The processing circuit 102 performs various kinds of information processing for exhibiting functions of the transmission side facility 3 and the reception side facility 4. For example, the processing circuit 102 includes a processor 103 and a memory 104. The processor 103 carries out various information processing by executing the program. The memory 104 stores a program executed by the processor 103 and various information necessary for executing the program. Examples of the memory 104 include a volatile memory, non-volatile memory, HDD (Hard Disk Drive), SSD (Solid State Drive), and so on.

The processing circuit 102 may be implemented using hardware such as an application specific integrated circuit (ASIC), a programmable logic device (PLD), or a field programmable gate array (FPGA).

The control device 5 can also be implemented by a computer and a program, and the program can be stored in a storage medium or provided through a network.

Although the embodiments of the present invention have been described above, the present invention is not limited to the above-described embodiments, and various modifications can be made without departing from the scope of the present invention. That is, the present invention is not limited to the mentioned numbers except for a case in which numbers such as the number, quantity, amount, or range of each element are mentioned in the above embodiment, a case in which the numbers are particularly specified, or a case in which the numbers are clearly specified in principle. Also, the structures and the like described in the above-described embodiments are not necessarily essential to the present invention unless otherwise specified or clearly specified in principle.

### REFERENCE SIGNS LIST

1 Optical fiber transmission route
2 Transmission route
3 Transmission side facility
4 Reception side facility
5 Control device
6.8 Optical transmission device
7.9 Wireless device
51 Section water vapor amount calculation unit
52 Rainfall amount prediction unit
53 Communication scheme determination unit
61, 71, 81, 91 Data communication unit
62, 82 Optical transmission/reception unit
63, 73, 83, 93 Clock unit
72.92 Wireless transmission/reception unit
74.94 Wireless modulation/demodulation unit
101 Transmission/reception interface
102 Processing circuit
103 Processor
104 Memory

1. A communication system that has an optical fiber transmission route and a wireless transmission route, the communication system comprising:
a transmission side facility connected to one end of the optical fiber transmission route and one end of the wireless transmission route and configured to transmit signals to both the optical fiber transmission route and the wireless transmission route at the same transmission timing before rainfall; and
a reception side facility connected to the other end of the optical fiber transmission route and the other end of the wireless transmission route and configured to measure a delay amount of a signal through the wireless transmission route with respect to a signal through the optical fiber transmission route based on a difference between a reception timing at which the signal is received from the optical fiber transmission route and a reception timing at which the signal is received from the wireless transmission route,
wherein, when a predicted rainfall amount corresponding to the delay amount is equal to or greater than a threshold or when the predicted rainfall amount based on a rate of increase of the delay amount is equal to or greater than the threshold, the transmission side facility raises transmission power of a signal transmitted to the wireless transmission route compared with transmission power in a normal time in which the predicted rainfall amount is less than the threshold or changes a modulation scheme to a scheme more resistant to rainfall than in the normal time.

2. The communication system according to claim 1,
wherein the transmission side facility includes an optical transmitter and a wireless transceiver, and
wherein, at the same transmission timing before rainfall, the optical transmitter transmits a timing signal as the signal to the optical fiber transmission route, and the wireless transceiver transmits the timing signal supplied from the optical transmitter to the wireless transmission route.

3. The communication system according to claim 1,
wherein the transmission side facility includes a wireless transceiver and an optical transmitter,
wherein the signal includes a wireless synchronization signal, and
wherein, at the same transmission timing before rainfall, the wireless transceiver transmits the wireless synchronization signal to the wireless transmission route: and the optical transmitter transmits a superimposed signal obtained by superimposing the wireless synchronization signal supplied from the wireless transceiver on a main signal to an optical fiber transmission route.

4. The communication system according to claim 1,
wherein the transmission side facility includes a wireless transceiver and an optical transmitter,
wherein the signal includes a wireless modulation signal including a wireless synchronization signal and important communication data,
wherein, at the same transmission timing before rainfall, the wireless transceiver transmits the wireless modulation signal to the wireless transmission route and the optical transmitter transmits a superimposed signal obtained by superimposing the wireless modulation signal supplied from the wireless transceiver on a main signal to the optical fiber transmission route, and
wherein, when the wireless communication through the wireless transmission route is interrupted, the reception side facility compensates for the wireless communication through the wireless transmission route with the important communication data included in the wireless modulation signal separated from the superimposed signal received through the optical fiber transmission route.

5. The communication system according to claim 1,
wherein the reception side facility estimates the water vapor amount in a wireless section in which the wireless transmission route is used based on the delay amount or a rate of increase of the delay amount,
wherein the reception side facility calculates the predicted rainfall amount based on the estimated water vapor amount,
wherein, when the predicted rainfall amount is equal to or more than the threshold, the reception side facility notifies the transmission side facility with a control signal for raising transmission power of a signal to be transmitted to the wireless transmission route compared with transmission power in the normal time or changing a modulation scheme to a scheme more resistant to rainfall than in the normal time, and
wherein the transmission side facility changes the transmission power or the modulation scheme of the signal to be transmitted to the wireless transmission route in accordance with the control signal.

6. The communication system according to claim 1, wherein, when the predicted rainfall amount is equal to or greater than the threshold, the transmission side facility changes the modulation scheme to a scheme having a lower multi-value number than in the normal time, or changes the modulation scheme to a scheme having a higher error correction capability than in the normal time.

7. A communication method of a communication system in which a transmission side facility and a reception side facility are connected through two routes which are an optical fiber transmission route and a wireless transmission route, the method comprising:
transmitting signals from the transmission side facility to both the optical fiber transmission route and the wireless transmission route at the same transmission timing before rainfall;
measuring a delay amount of a signal through the wireless transmission route with respect to a signal through the optical fiber transmission route based on a difference between a reception timing at which the signal is received from the optical fiber transmission route and a reception timing at which the signal is received from the wireless transmission route: and
raising transmission power of a signal transmitted from the transmission side facility to the wireless transmission route compared with transmission power in a normal time in which the predicted rainfall amount is equal to or greater than a threshold or changing a modulation scheme to a scheme more resistant to rainfall than in the normal time when the predicted rainfall amount corresponding to the delay amount is less than the threshold or when the predicted rainfall amount based on a rate of increase of the delay amount is equal to or greater than the threshold.

8. A control device of a reception side facility connected to a transmission side facility through two routes which are an optical fiber transmission route and a wireless transmission route,
wherein the transmission side facility transmits signals to both the optical fiber transmission route and the wireless transmission route at the same transmission timing before rainfall,
wherein the control device comprises:
water vapor amount calculation circuitry configured to measure a delay amount of a signal through the wireless transmission route with respect to a signal through the optical fiber transmission route based on a difference between a reception timing at which the signal is received from the optical fiber transmission route and a reception timing at which the signal is received from the wireless transmission route and to estimate a water vapor amount in the wireless section in which the wireless transmission route is used based on the delay amount or the rate of increase of the delay amount:
rainfall amount prediction circuitry configured to calculate a predicted rainfall amount based on the predicted water vapor amount; and
communication scheme determination circuitry configured to notify the transmission side facility with a control signal for raising transmission power of a signal to be transmitted to the wireless transmission route compared with transmission power in a normal time in which the predicted rainfall amount is less than the threshold or changing a modulation scheme to a scheme more resistant to rainfall than in the normal time when the predicted rainfall amount is equal to or more than the threshold, and
wherein the transmission side facility changes the transmission power or the modulation scheme of a signal to be transmitted to the wireless transmission route in accordance with the control signal.
